(19) United States
(12) Patent Application Publication
(10) Pub. No.: US 2025/0140073 A1
(43) Pub. Date: May 1, 2025

(54) INFORMATION PROCESSING DEVICE, INFORMATION PROCESSING METHOD AND INFORMATION PROCESSING PROGRAM

(71) Applicant: MIXI, INC., Tokyo (JP)

(72) Inventors: Masayuki ITAKURA, Tokyo (JP); Yuki TOYOSHIMA, Tokyo (JP)

(73) Assignee: MIXI, INC., Tokyo (JP)

(21) Appl. No.: 18/730,451

(22) PCT Filed: Oct. 3, 2022
(86) PCT No.: PCT/JP2022/036977

§ 371 Date: Jul. 19, 2024

(30) Foreign Application Priority Data
Feb. 4, 2022 (JP) 2022-016292

(51) Int. Cl. G07F 17/32; G06Q 50/34

(52) U.S. Cl. CPC G07F 17/3288; G06Q 50/34; G07F 17/323; G07F 17/3276; G07F 17/3281

(57) ABSTRACT

An information processing device includes a processor, wherein the processor accepts a bet of a betting ticket specifying a betting content based on an operation to specify a competition for betting by a first user and an operation to specify a betting content for betting for the specified competition, the processor accepts a specification of a first betting ticket from at least one betting ticket bet by the first user, the processor accepts a bet of a second betting ticket that specifies the same betting content as the first betting ticket by accepting an operation to specify the first betting ticket by a second user, and the processor sets a dividend ratio of the second betting ticket by adding a first additional dividend ratio to a first basic dividend ratio defined in the second betting ticket when the second user bets on the second betting ticket.

### TECHNICAL FIELD

The present embodiment relates to an information processing device, an information processing method, and an information processing program.

### BACKGROUND ART

Conventionally, there are known betting systems that allow betting in various events where betting is conducted, such as horse racing, bicycle racing, auto racing, or boat racing, for example, by means of mobile terminals. For example, Patent Literature 1 describes a betting system that allows a bettor to purchase a betting ticket using a mobile terminal.

### CITATION LIST

### Patent Literature

[Patent Literature 1] JP-A-2013-114487

### SUMMARY OF INVENTION

### Technical Problem

The betting method employed in a competition where betting is performed is complex. For example, in the case of horse racing, after specifying a betting type, such as “win”, “show”, a bettor needs to perform multiple operations to specify a target of a betting, such as “first place is number 5, second place is number 3,” and a number or amount of bets of a given value on the target of the betting. Therefore, when a bettor bets, there was a problem in that an operational load was large and erroneous operation was likely to occur.

One object of present embodiment is to provide an information processing device, an information processing method, and an information processing program that can reduce an operational load and prevent an occurrence of erroneous operation when a bettor bets.

### Solution to Problem

The information processing device according to an example of present embodiment is an information processing device comprising a processor, wherein the processor accepts a bet of a betting ticket specifying a betting content based on an operation to specify a competition for betting by a first user and an operation to specify the betting content for betting for the specified competition, the processor accepts a specification of a first betting ticket from at least one betting ticket bet by the first user, the processor accepts a bet of a second betting ticket that specifies the same betting content as the first betting ticket by accepting an operation to specify the first betting ticket by a second user, and the processor sets a dividend ratio of the second betting ticket by adding a first additional dividend ratio to a first basic dividend ratio defined in the second betting ticket when the second user bets on the second betting ticket.

According to an example of the present embodiment, it is possible to reduce an operational load and to prevent an occurrence of erroneous operation when a bettor bets by encouraging another user to bet for a betting ticket that specifies the same betting content as a betting ticket specified from among betting tickets bet by a user with an aim of increasing a dividend ratio.

### BRIEF DESCRIPTION OF DRAWINGS

FIG. 1 is a diagram showing a configuration of a betting system in a first embodiment.

FIG. 2 is a block diagram showing a hardware configuration of a server in the first embodiment.

FIG. 3 is a block diagram showing a hardware configuration of a user terminal in the first embodiment.

FIG. 4 is a block diagram showing an example of a functional configuration of the server in the first embodiment.

FIG. 5 is a sequence diagram of the server and the user terminal in the first embodiment.

FIG. 6 is an example of a screen displayed on a display unit of the user terminal.

FIG. 7 is an example of a screen displayed on the display unit of the user terminal.

FIG. 8 is an example of a screen displayed on the display unit of the user terminal.

FIG. 9 is an example of a screen displayed on the display unit of the user terminal.

FIG. 10 is an example of a screen displayed on the display unit of the user terminal.

FIG. 11 is an example of a screen displayed on the display unit of the user terminal.

FIG. 12 is a block diagram showing an example of a functional configuration of the server in a second embodiment.

FIG. 13 is a block diagram showing an example of a functional configuration of the server in a third embodiment.

### DESCRIPTION OF EMBODIMENTS

### First Embodiment

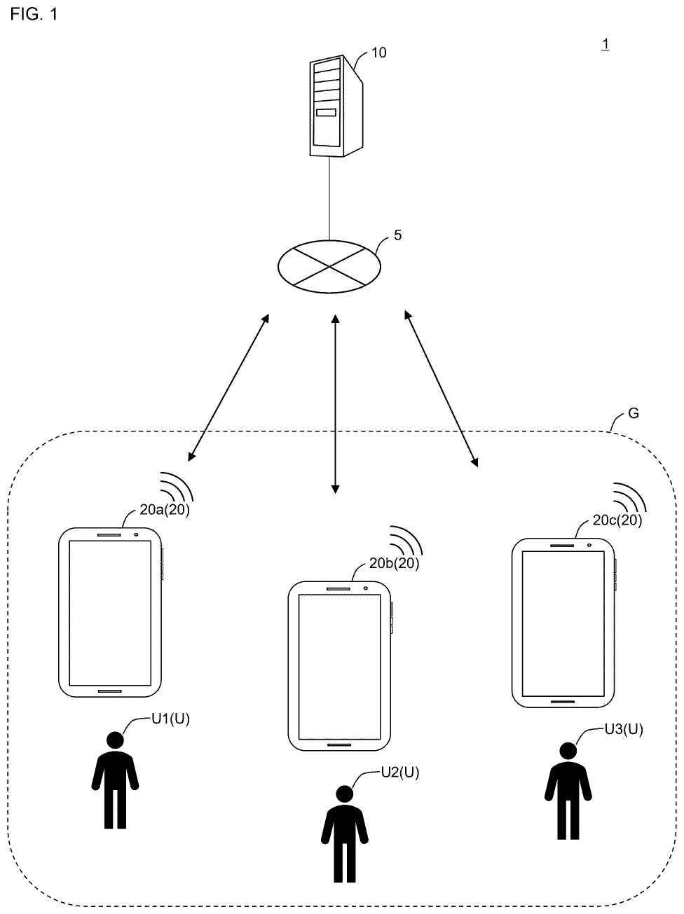

Hereinafter, a first embodiment, which is an example of present embodiment, will be described based on the drawings. FIG. 1 shows a configuration of a betting system 1 in present embodiment. The betting system 1 is a system that manages bets by users in various competitions where betting is performed, such as horse racing, bicycle racing and boat racing.

In present embodiment, a case where the betting system 1 is used for horse racing will be explained as an example. However, the betting system 1 is not limited to horse racing, and may be used in various competitions where betting is performed, such as bicycle racing and boat racing, and motorcycle racing. Further, the betting system 1 may be used for various competitions where rankings are defined. Further, the betting system 1 may be used for simulation games, etc. regarding the various competitions described above.

As shown in FIG. 1, the betting system 1 includes a server 10 and a plurality of user terminals 20 (a user terminal 20a, a user terminal 20b, a user terminal 20c) belonging to the same group G. The server 10 and the plurality of user terminals 20 are communicably connected to each other via a communication line 5 such as the Internet or a wireless LAN. It is noted that the server 10 functions as an “information processing device” in an example of present embodiment.

A group G is a group that can use a betting service provided by the betting system 1 and is configured by a plurality of users U. The minimum number of users for configuring the group G is set to, for example, two users. In present embodiment, the group G is a group configured by a user U1, a user U2 and a user U3. The user U1, the user U2 and the user U3 are, for example, the users U who are friends with each other, and are users U who mutually approved each other (also referred to as friends).

In present embodiment, the users who use the user terminal 20a, the user terminal 20b, and the user terminal 20c are assumed to be the user U1, the user U2, and the user U3, respectively. If there is no need to distinguish between the users U1, U2 and U3, each of the users U1, U2 and U3 will be expressed as a user U.

Further, if there is no need to distinguish between the user terminal 20a, the user terminal 20b and the user terminal 20c, the user terminal 20a, the user terminal 20b and the user terminal 20c are each expressed as the user terminal 20.

It is noted that the number of user terminals 20 included in the betting system 1 is not limited to three, and it is sufficient that the betting system 1 includes at least one user terminal 20.

The user terminal 20 is, for example, an information processing terminal such as a smartphone or a tablet terminal. It is noted that the user terminal 20 may be any terminal, such as a mobile phone, a personal computer (PC), a notebook PC, a personal digital assistant (PDA), or a home game device.

The server 10 may be configured by one device or a plurality of devices. Further, the server 10 may be a server implemented on a cloud.

A summary of betting performed using the betting system 1 will be explained with reference to FIG. 1. First, the user U accesses the server 10 by operating the user terminal 20. Next, after accessing the server 10, the user U inputs information (for example, user ID, password, etc.) for uniquely identifying the user U into the user terminal 20 in order to log in to the server 10. The input information is transmitted from the user terminal 20 to the server 10 via the communication line 5.

Next, the server 10 identifies the user U using the betting system 1 based on the information received from the user terminal 20. Next, the server 10 generates information including information for displaying a betting screen and transmits it to the user terminal 20.

Next, the user terminal 20 displays a betting screen based on the screen information received from the server 10. The user U then bets using the betting screen displayed on the user terminal 20. Here, the betting screen is a screen for user U to bet. For example, in the case of horse racing, betting types such as “win”, “show”, “bracket quinella”, “quinella”, “exacta”, “quinella place”, “trio”, “tierce”, betting targets, and choices of the number of bets or bet amount of a predetermined value for the betting target are displayed on the betting screen. The user U can predict a result of a competition (horse racing) and bet on the result of the competition, by setting a betting type, a betting target and the number or bet amount of a predetermined value for the betting target using the betting screen and purchasing a betting ticket (horse racing ticket) based on the set contents using a predetermined value.

If the competition subject to betting is horse racing, the betting target may be, for example, “the exacta where the first place is number 5 and the second place is number 3” or “the trio where racehorses numbered 1, 2 and 5 are selected”. In addition, the exacta means predicting the first and second place racehorses according to the order of their finish. The trio means predicting racehorses that finishes first to third, regardless of their order of finish.

The predetermined value may be money, or points that can be used in a predetermined service or game. Further, the points may be points (free points) that the bettor can receive for free, or points (paid points) that can be received in exchange for payment of money.

When the betting by the user U is completed, the input betting information is transmitted from the user terminal 20 to the server 10 via the communication line 5. Thereafter, the server 10 determines whether or not the bet by the user U comes true based on the actual race results, and transmits determination result information indicating the determination result to the user terminal 20. The user terminal 20 then displays the determination result information received from the server 10. The user U can confirm whether the betting performed by the user U comes true or not by referring to the determination result information displayed on the user terminal 20. When the bet performed by the user U comes true, the user U can receive a refund value (for example, money or points) defined based on the size of the predetermined value used in the bet and the dividend ratio (dividend ratio) of the betting target.

### Hardware Configuration of Server 10

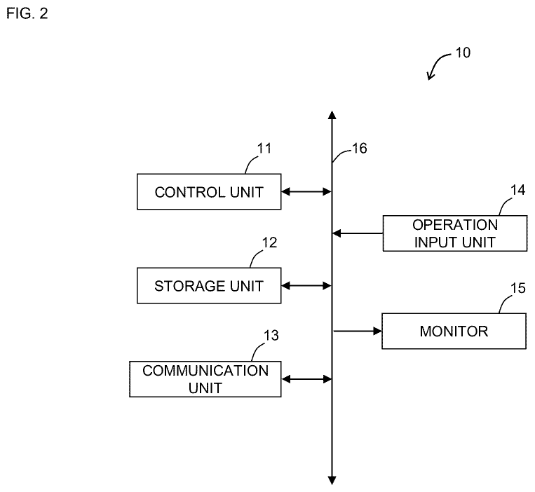

FIG. 2 is a block diagram showing the hardware configuration of the server 10 in present embodiment. As shown in FIG. 2, the server 10 is configured to include a control unit 11, a storage unit 12, a communication unit 13, an operation input unit 14, and a monitor 15.

The control unit 11 is, for example, a CPU (Central Processing Unit), a microprocessor, a DSP (Digital Signal Processor), etc., and controls the overall operation of the server 10. It is noted that the control unit 11 functions as a “processor” in an example of present embodiment.

A part of the storage unit 12 is configured by, for example, RAM (Random Access Memory), DRAM (Dynamic Random Access Memory), etc., and is used as a work area etc. when the control unit 11 executes processing based on various programs.

Further, a part of the storage unit 12 is, for example, a nonvolatile memory such as a ROM (Read Only Memory) or an HDD (Hard Disk Drive), and stores various data and programs used for processing of the control unit 11. The storage unit 12 can hold a database including one or more tables, etc. for recording various information and processing results, etc.

The programs stored in the storage unit 12 include, for example, an OS (Operating System) for realizing the basic functions of the server 10, drivers for controlling various hardware, programs for realizing various functions, etc. The programs stored in the storage unit 12 includes a program that functions as an “information processing program” as an example of present embodiment.

The communication unit 13 is, for example, a NIC (Network Interface Controller), and has a function of connecting to the communication line 5. It is noted that the communication unit 13 may have a function of connecting to a wireless LAN (Local Area Network), a function of connecting to a wireless WAN (Wide Area Network), instead of or together with the NIC, for example, functions that enable short-range wireless communication such as Bluetooth (registered trademark), and infrared communication, etc. The server 10 is connected to the user terminal 20, etc. like via the communication line 5, and can transmit and receive various data to and from the user terminal 20, etc.

The operation input unit 14 is configured by a keyboard, a mouse, etc., and accepts various operation inputs from a user using the server 10. The monitor 15 is, for example, a liquid crystal display device, and displays various images.

The control unit 11, the storage unit 12, the communication unit 13, the operation input unit 14, and the monitor 15 are electrically connected to each other via a system bus 16. Therefore, the control unit 11 can access the storage unit 12, display images on the monitor 15, understand the operation status on the operation input unit 14 by the user, and access various communication networks and user terminals 20 via the communication unit 13.

### Hardware Configuration of User Terminal 20

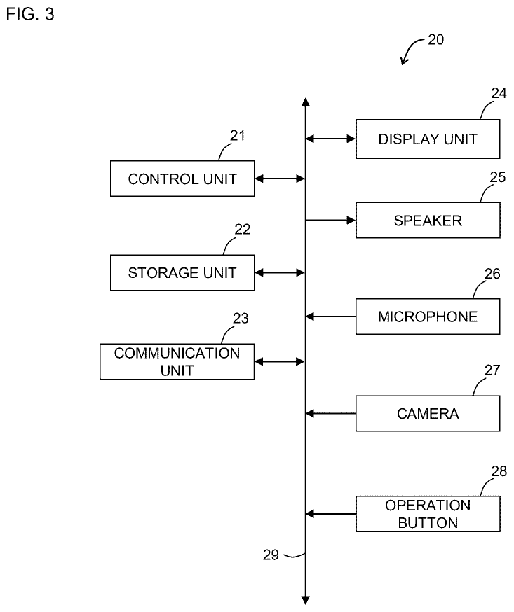

FIG. 3 is a block diagram showing the hardware configuration of the user terminal 20 in present embodiment. As shown in FIG. 3, the user terminal 20 is configured to include a control unit 21, a storage unit 22, a communication unit 23, a display unit 24, a speaker 25, a microphone 26, a camera 27 and an operation button 28.

The control unit 21 is, for example, a CPU (Central Processing Unit), a microprocessor, a DSP (Digital Signal Processor), etc., and controls the overall operation of the user terminal 20.

A part of the storage unit 22 is configured by, for example, RAM (Random Access Memory), DRAM (Dynamic Random Access Memory), etc., and is used as a work area etc. when the control unit 21 executes processing based on various programs.

Further, a part of the storage unit 22 is, for example, a nonvolatile memory such as a ROM (Read Only Memory) or an HDD (Hard Disk Drive), and stores various data and programs used for processing of the control unit 21. The storage unit 22 can hold a database including one or more tables, etc. for recording various information and processing results, etc.

The programs stored in the storage unit 22 include, for example, an OS (Operating System) for realizing the basic functions of the user terminal 20, drivers for controlling various hardware, programs for realizing various functions, etc.

The communication unit 23 is, for example, a NIC (Network Interface Controller), and has a function of connecting to the communication line 5. It is noted that the communication unit 23 may have a function of connecting to a wireless LAN (Local Area Network), a function of connecting to a wireless WAN (Wide Area Network), instead of or together with the NIC, for example, functions that enable short-range wireless communication such as Bluetooth (registered trademark), and infrared communication, etc. The user terminal 20 is connected to the server 10, other user terminals 20, etc. via the communication line 5, and can transmit and receive various data between the server 10, other user terminals 20, etc.

The display unit 24 is a touch panel display, etc., and can display images, etc. and accept operations by the user U.

The speaker 25 outputs various sounds under the control of the control unit 21. The microphone 26 inputs various sounds under the control of the control unit 21. The camera 27 captures an image of a subject under the control of the control unit 21.

The operation button 28 is provided, for example, on the side surface of the user terminal 20, and is a power button for starting or stopping the user terminal 20, a button for adjusting the volume of the sound output from the speaker 25, etc.

The control unit 21, the storage unit 22, the communication unit 23, the display unit 24, the speaker 25, the microphone 26, the camera 27, and the operation button 28 are electrically connected to each other via a system bus 29. Therefore, the control unit 21 can access the storage unit 22, display images on the display unit 24, understand the operation state of the touch panel display (the display unit 24) and the operation button 28 by the user U, input sound to the microphone 26, output sound from the speaker 25, control the camera 27, and access various communication networks, the server 10, other user terminals 20, etc. via the communication unit 23.

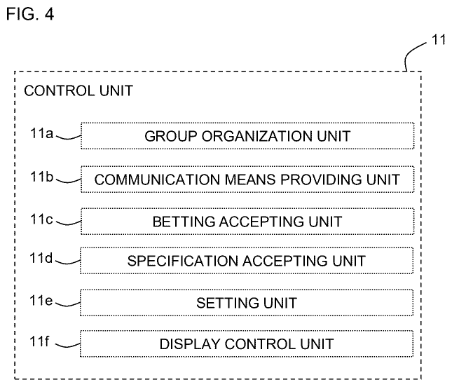

FIG. 4 is a block diagram showing an example of the functional configuration of the control unit 11 included in the server 10 in the first embodiment. As shown in FIG. 4, the control unit 11 includes a group organization unit 11a, a communication means providing unit 11b, a betting accepting unit 11c, a specification accepting unit 11d, a setting unit 11e, and a display control unit 11f as functional configurations. Although the control unit 11 of the server 10 generally has various functions in addition to those described above, only the functions that are characteristic of the betting system 1 in the first embodiment will be explained here, and other known functions will be omitted from illustration and description.

The group organization unit 11a accepts a request from the user U regarding an organization of a group (the group G in present embodiment). The group organization unit 11a also performs processes such as creating a new group, adding user U to a group, excluding user U from a group, and deleting a group based on a request from user U or predetermined conditions.

The communication means providing unit 11b provides communication means in the virtual space to a plurality of users (the user U1, the user U2, the user U3) belonging to the group G. The communication means is provided as one of the communication tools in SNS (Social Networking Service). Each user U (the user U1, the user U2, the user U3) belonging to the group G can communicate by using communication means such as voice chat, text chat or video chat.

The betting accepting unit 11c accepts bets using a betting ticket with betting contents specified based on an operation for specifying a competition (in present embodiment, horse racing) for betting by the first user and an operation for specifying betting contents (for example, betting type, betting target, predetermined value of betting amount, etc.) for betting in a specified competition, from the user terminal 20 operated by the first user (the user U1 in present embodiment). Then, the betting accepting unit 11c causes the storage unit 12, etc. to store betting information indicating the betting contents specified in the betting ticket where the bet was accepted.

The specification accepting unit 11d accepts a specification of a first betting ticket that is a betting ticket where a dividend ratio is to be increased from among at least one betting ticket (specifically, betting target) bet for the competition by the first user. The user U1 and users U2 and U3 that belong to the same group G as user U1 can specify the first betting ticket.

The specification accepting unit 11d controls so that the first betting ticket can be specified from betting tickets shared with other users (in present embodiment, the users U2 and U3) by the first user (in present embodiment, the user U1). For example, the user U1 can specify the first betting ticket from before to after sharing the betting ticket that the user U1 bet for. Further, the users U2 and U3 can specify the first betting ticket after the betting ticket is shared by the user U1.

The betting accepting unit 11c accepts bets of the second betting ticket that specifies the same betting content (including the competition for betting) as the first betting ticket by accepting an operation to specify the first betting ticket by the second user (in present embodiment, the users U2 and U3), from the user terminals 20 operated by the second users. Specifically, the betting accepting unit 11c receives specific information (for example, betting ID) that is transmitted from the user terminal 20 operated by the second user and uniquely identifies the first betting ticket. Here, bets of the second betting ticket that specifies the same betting content as the first betting ticket is betting on a betting ticket that has the same betting target, or at least a part of it, as the betting target of the first betting ticket (also called shared betting).

The setting unit 11e sets a dividend ratio of the second betting ticket by adding a first additional dividend ratio to a first basic dividend ratio defined in the second betting ticket when the second user (the users U2 and U3 in present embodiment) bet on the second betting ticket.

In the present embodiment, the setting unit 11e sets a dividend ratio of the second betting ticket by adding a first additional dividend ratio to a first basic dividend ratio defined in the second betting ticket (specifically, the betting target) at the time when the second betting ticket is bet. It is noted that the setting unit 11e sets a dividend ratio of the second betting ticket by adding a first additional dividend ratio to a first basic dividend ratio defined in the second betting ticket (specifically, the betting target) at the time after the second betting ticket was bet (for example, at the deadline for betting). In present embodiment, the first additional dividend ratio are set based on a specification of the first user (the user U1 in present embodiment).

The display control unit 11f displays various information on the display unit 24 of the user terminal 20 that can be used by each user when the communication means providing unit 11b provides communication means in the virtual space to a plurality of users (the user U1, the user U2, the user U3) belonging to the group G.

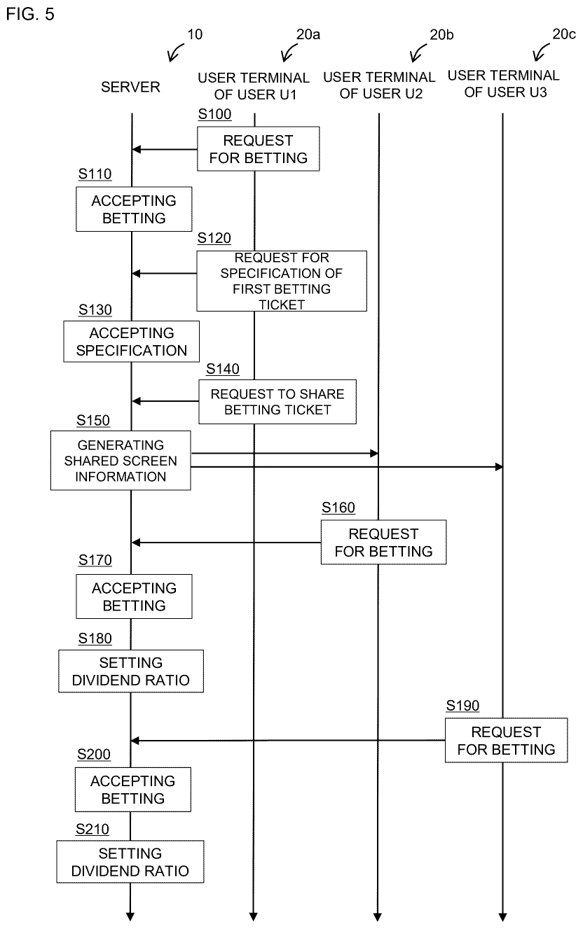

FIG. 5 is a sequence diagram of the server 10 and the user terminal 20 in present embodiment (corresponding to the “information processing method” as an example of present embodiment) when betting of the second betting ticket that specifies the same betting content as the first betting ticket by the second user (the user U2, the user U3) performing an operation to specify the first betting ticket specified by the first user (the user U1).

First, the user terminal 20a that can be used by the first user (the user U1) transmits betting request information, which is accepted through an operation on the display unit 24, indicating that a bet of a betting ticket with betting contents specified based on an operation for specifying a competition (in present embodiment, horse racing) for betting by the first user and an operation for specifying betting contents (for example, betting type, betting target, predetermined value of betting amount, etc.) for betting in a specified competition is requested to the server 10 (step S100).

Next, the betting accepting unit 11c of the server 10 receives the betting request information transmitted from the user terminal 20a, and accepts the bet of the betting ticket where betting contents are specified by the first user (step S110).

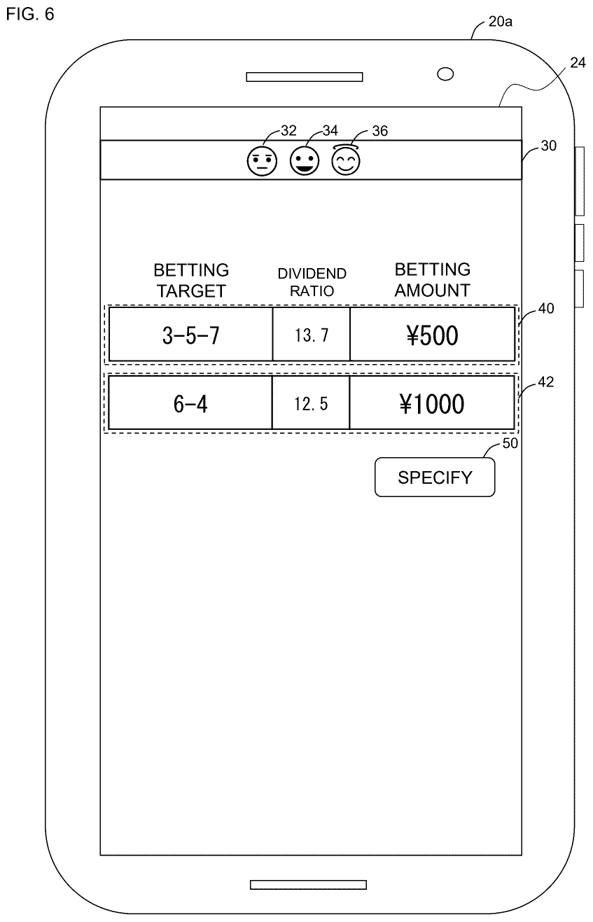

FIG. 6 is an example of a screen displayed on the display unit 24 of the user terminal 20a when the betting accepting unit 11c accepts the bet of the user U1.

As shown in FIG. 6, the display control unit 11f of the server 10 displays, on the display unit 24 of the user terminal 20a, specific information that specifies a plurality of users (the user U1, the user U2, the user U3) belonging to the group G, betting ticket information that indicates the contents of the betting ticket corresponding to the bet of the user U1 accepted by the betting accepting unit 11c, and a button 50 for specifying the first betting ticket from among the betting tickets corresponding to the bet of the user U1. The user U1 using the user terminal 20a can understand the contents of the bet the user U1 bet by checking the screen shown in FIG. 6,

Specifically, the display control unit 11f displays face icons 32, 34, and 36 that respectively specify the users U1, U2, and U3 belonging to the group G as specific information in a display area 30 of the display unit 24. Further, the display control unit 11f displays betting ticket information (betting target, dividend ratio, betting amount) indicating the contents of each betting ticket corresponding to the bet of the user U1 in display areas 40 and 42 of the display unit 24.

The betting ticket information displayed in the display area 40 shows “the trio where racehorses numbered 3, 5 and 7 are selected” as the betting target, “13.7 times” as the dividend ratio, and “500 yen” as the betting amount. In addition, the betting ticket information displayed in the display area 42 shows “the exacta where the first place is number 6 and the second place is number 4” as the betting target, “12.5 times” as the dividend ratio, and “1000 yen” as the betting amount.

Returning to the sequence diagram of FIG. 5, the user terminal 20a that can be used by the first user (the user U1) transmits specification request information that is accepted from the user U1 through an operation on the display unit 24 and indicating that a request is made to specify the first betting ticket to the server 10 (step S120). In present embodiment, the user U1 checks the screen shown in FIG. 6, selects the betting ticket corresponding to the betting ticket information displayed in the display area 40, and presses the button 50. Thereby, the user terminal 20a transmits the specification request information indicating that the user U1 requests specification of the first betting ticket (specifically, the betting ticket corresponding to the betting ticket information displayed in the display area 40) to the server 10.

Next, the specification accepting unit 11d receives the specification request information transmitted from the user terminal 20a, and accepts a specification of the first betting ticket subject to increase in a dividend ratio from among the betting tickets bet for the competition by user U1 (step S130).

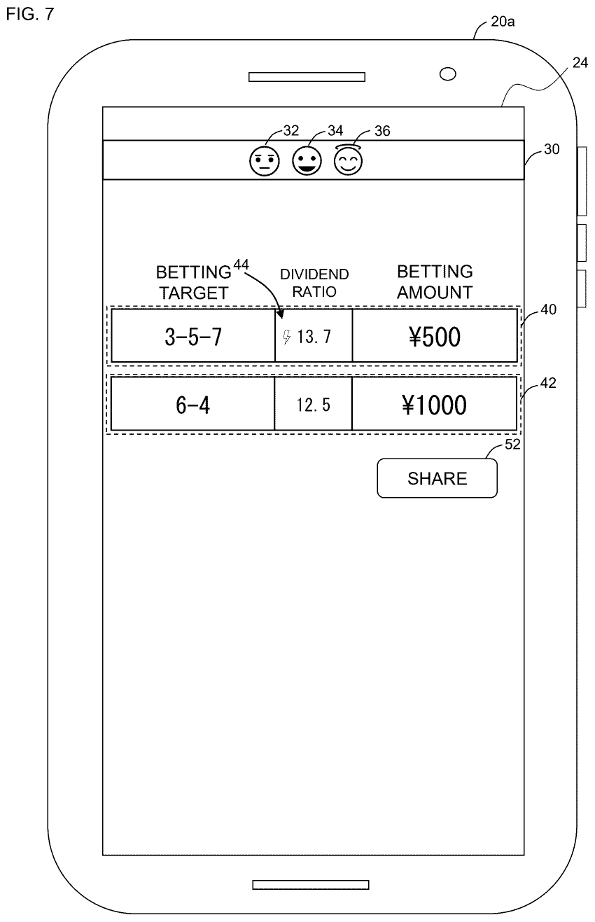

FIG. 7 is an example of a screen displayed on the display unit 24 of the user terminal 20a when the specification accepting unit 11d accepts the specification of the first betting ticket.

As shown in FIG. 7, the display control unit 11f of the server 10 displays, on the display unit 24 of the user terminal 20a, specific information that specifies a plurality of users (the user U1, the user U2, the user U3) belonging to the group G, betting ticket information indicating the contents of the betting ticket corresponding to the bet of the user U1 accepted by the betting accepting unit 11c, a button 52 for sharing the betting ticket corresponding to the bet of the user U1 with other users (the user U2, the user U3). In the present embodiment, because the betting ticket corresponding to the betting ticket information displayed in the display area 40 is specified as the first betting ticket, an icon 44 indicating that the betting ticket subject to increase in the dividend ratio is displayed in the area of the dividend ratio in the display area 40.

Returning to the sequence diagram of FIG. 5, the user terminal 20a that can be used by the first user (the user U1) transmits sharing request information that is received from the user U1 through an operation on the display unit 24 and indicating a request to share the betting ticket corresponding to the bet of the user U1 to the server 10 (step S140). In present embodiment, the user U1 confirms the screen shown in FIG. 7 and presses the button 52. Thereby, the user terminal 20a transmits sharing request information indicating a request to share the betting ticket corresponding to the bet of the user U1 to the server 10.

Next, the display control unit 11f of the server 10 receives the sharing request information transmitted from the user terminal 20a, and generates shared screen information for displaying a shared screen for sharing betting tickets corresponding to the bet of the user U1 with other users (the users U2, U3) (step S150). Then, the display control unit 11f transmits the generated shared screen information to the user terminals 20b and 20c.

The user terminals 20b and 20c display a shared screen on the display unit 24 based on the shared screen information received from the server 10. Thereby, the contents of the betting ticket corresponding to the bet of the user U1 are shared with the users U2 and U3 that confirmed the shared screen displayed on the display unit 24.

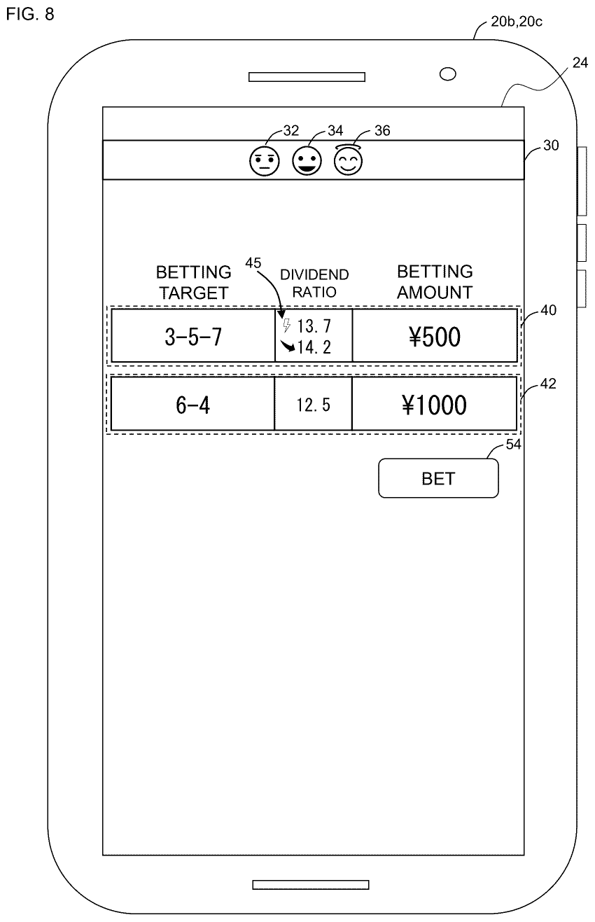

FIG. 8 is an example of a shared screen displayed on the display unit 24 of the user terminals 20b and 20c. As shown in FIG. 8, specific information that identifies a plurality of users (the user U1, the user U2, the user U3) belonging to the group G, betting ticket information that indicates the contents of the betting ticket corresponding to the bet of the user U1 accepted by the betting accepting unit 11c, and a button 54 for betting with the same content as the betting ticket corresponding to the bet of the user U1 are displayed on the display unit 24 of the user terminals 20b and 20c. In present embodiment, since the betting ticket corresponding to the betting ticket information displayed in the display area 40 is specified as the first betting ticket, in the area of the dividend ratio in the display area 40, an icon 45 indicating that the betting ticket is subject to an increase in the dividend ratio (more specifically, the betting ticket is subject to an increase in the dividend ratio from 13.7 times (the first basic dividend ratio) to 14.2 times (the rate obtained by adding the first additional dividend ratio (0.5 times) to the first basic dividend ratio)) is displayed. In this way, the display control unit 11f displays the first betting ticket (the betting ticket corresponding to the betting ticket information displayed in the display area 40) and the betting ticket that is not specified as the first betting ticket (the betting ticket that is displayed in the display area 42) in an identifiable manner regarding the betting ticket where the first user (the user U1) shared with other users (the users U2, U3) depending on whether or not the icon 45 is displayed.

Returning to the sequence diagram of FIG. 5, the user terminal 20b that can be used by the second user (the user U2) transmits betting request information that is accepted from user U2 through an operation on the display unit 24 (an operation where the second user specifies the first betting ticket) and indicating a request for betting for a second betting ticket that specifies the same betting content as the first betting ticket to the server 10 (step S160). In present embodiment, the user U2 confirms the shared screen shown in FIG. 8 and presses the button 54. Thereby, the user terminal 20b transmits betting request information indicating a request for betting with the same content as the betting ticket (including the first betting ticket) corresponding to the bet of the user U1 to the server 10.

Next, the betting accepting unit 11c of the server 10 receives the betting request information transmitted from the user terminal 20b, and accepts the bet of the user U2 for the second betting ticket with the same content as the betting ticket (including the first betting ticket) corresponding to the bet of the user U1 (step S170).

Next, the setting unit 11e sets the dividend ratio (14.2 times) of the second betting ticket by adding the first additional dividend ratio (0.5 times) to the first basic dividend ratio (13.7 times) specified in the second betting ticket since the user U2 bet for a betting ticket with the same contents as the betting ticket corresponding to the bet of the user U1 (more specifically, the user U2 bet on the second betting ticket that specified the same betting contents as the first betting ticket (the trio where racehorses numbered 3, 5 and 7 are selected) specified by the user U1) (step S180).

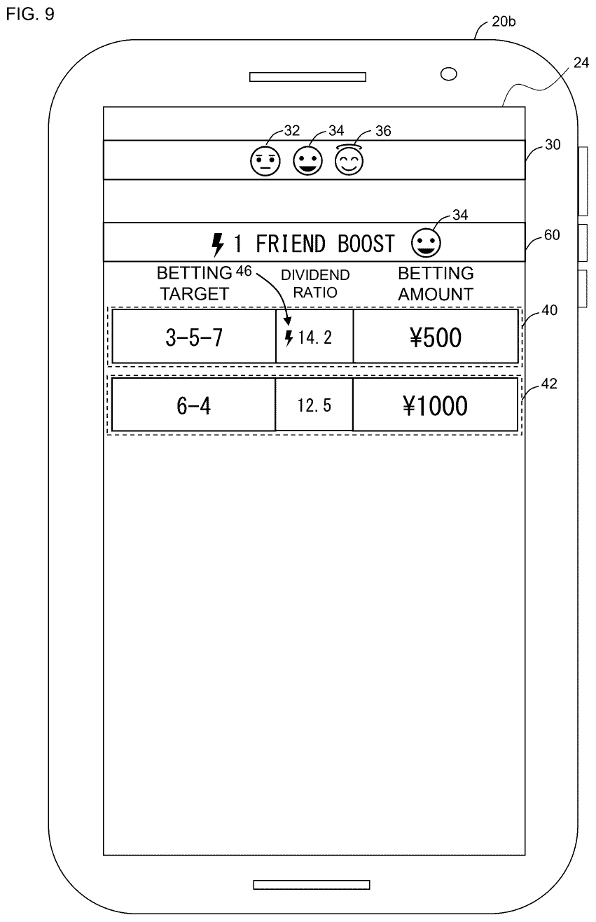

FIG. 9 is an example of a shared screen displayed on the display unit 24 of the user terminal 20b after the dividend ratio of the second betting ticket is set in step S180. As shown in FIG. 9, specific information identifying a plurality of users (the user U1, the user U2, the user U3) belonging to the group G, betting ticket information indicating the contents of the betting ticket corresponding to the bet of user U2 accepted by the betting accepting unit 11c, betting history information indicating that the user U2 bet for the second betting ticket specifying the same betting contents as the first betting ticket specified by the user U1 are displayed on the display unit 24 of the user terminal 20b.

Specifically, the display control unit 11f displays face icons 32, 34 and 36 that respectively specify the user U1, the user U2 and the user U3 belonging to the group G as the specific information in the display area 30 of the display unit 24. The display control unit 11f also displays betting ticket information (betting target, dividend ratio, betting amount) indicating the contents of the betting ticket corresponding to the bet of the user U2 in the display areas 40 and 42 of the display unit 24.

The betting ticket information displayed in the display area 40 indicates “the trio where racehorses numbered 3, 5 and 7 are selected” as the betting target, “14.2” as the dividend ratio, and “500 yen” as the betting amount. In addition, the betting ticket information displayed in the display area 42 indicates “the exacta where the first place is number 6 and the second place is number 4” as the betting target, “12.5” as the dividend ratio, and “1000 yen” as the betting amount. In the area of the dividend ratio in the display area 40, an icon 46 indicating that the dividend ratio were increased to 14.2 times by betting with the second betting ticket based on the first betting ticket specified by the user U1 is displayed.

The betting history information displayed in the display area 60 indicates that the user U2 (one user) identified by the face icon 34 bet for the second betting ticket based on the first betting ticket specified by the user U1.

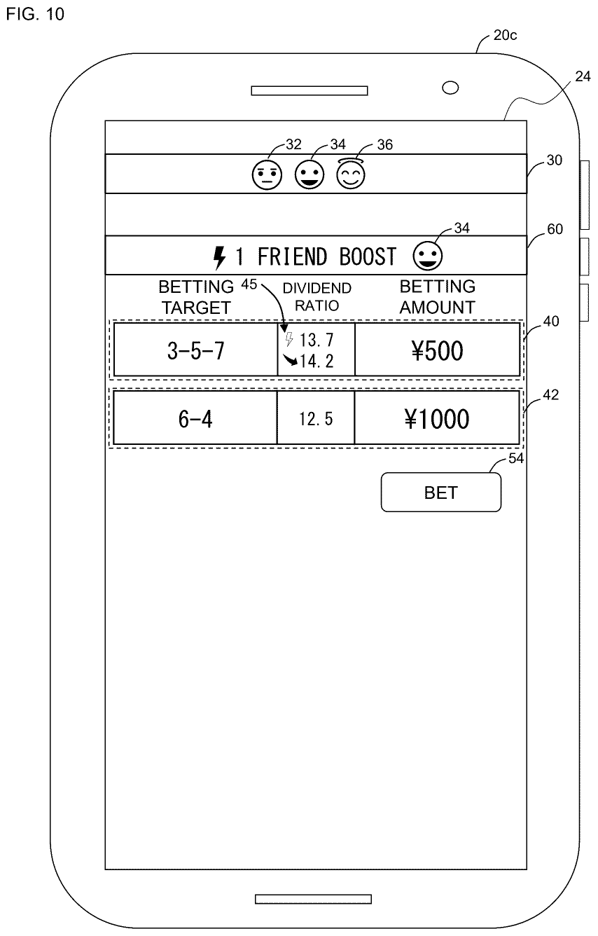

FIG. 10 is an example of a shared screen displayed on the display unit 24 of the user terminal 20c after the dividend ratio of the second betting ticket is set in the step S180. As shown in FIG. 10, specific information that identifies a plurality of users (the user U1, the user U2, the user U3) belonging to the group G, betting ticket information that indicates the contents of the betting ticket corresponding to the bet of the user U1 accepted by the betting accepting unit 11c, a button 54 for betting with the same content as the betting ticket corresponding to the bet of the user U1, and a betting history indicating that the user U2 bet for the second betting ticket based on the first betting ticket specified by user U1 are displayed on the display unit 24 of the user terminal 20c.

Specifically, the display control unit 11f displays face icons 32, 34 and 36 that respectively specify the user U1, the user U2 and the user U3 belonging to the group G as the specific information in the display area 30 of the display unit 24. The display control unit 11f also displays betting ticket information (betting target, dividend ratio, betting amount) indicating the contents of the betting ticket corresponding to the bet of the user U1 in the display areas 40 and 42 of the display unit 24.

The betting ticket information displayed in the display area 40 indicates “the trio where racehorses numbered 3, 5 and 7 are selected” as the betting target, “13.7” as the dividend ratio, and “500 yen” as the betting amount. In addition, the betting ticket information displayed in the display area 42 shows “the exacta where the first place is number 6 and the second place is number 4” as the betting target, “12.5” as the dividend ratio, and “1000 yen” as the betting amount. In present embodiment, since the betting ticket corresponding to the betting ticket information displayed in the display area 40 is specified as the first betting ticket, similar to the screen shown in FIG. 8, in the area of the dividend ratio in the display area 40, an icon 45 indicating that the betting ticket is subject to an increase in the dividend ratio (more specifically, the betting ticket is subject to an increase in the dividend ratio from 13.7 times (the first basic dividend ratio) to 14.2 times (the rate obtained by adding the first additional dividend ratio (0.5 times) to the first basic dividend ratio)) is displayed. In this way, the display control unit 11f displays the first betting ticket (the betting ticket corresponding to the betting ticket information displayed in the display area 40) and the betting ticket that is not specified as the first betting ticket (the betting ticket that is displayed in the display area 42) in an identifiable manner regarding the betting ticket where the first user (the user U1) shared with other users (the users U2, U3) depending on whether or not the icon 45 is displayed.

The betting history information displayed in the display area 60 indicates that the user U2 (one user) identified by the face icon 34 bet for the second betting ticket specifying the same betting contents as the first betting ticket specified by the user U1.

Returning to the sequence diagram of FIG. 5, the user terminal 20c that can be used by the second user (the user U3) transmits betting request information that is accepted from user U3 through an operation on the display unit 24 (an operation where the second user specifies the first betting ticket) and indicating a request for betting for a second betting ticket that specifies the same betting content as the first betting ticket to the server 10 (step S190). In present embodiment, the user U3 confirms the shared screen shown in FIG. 10 and presses the button 54. Thereby, the user terminal 20c transmits betting request information indicating a request for betting with the same content as the betting ticket (including the first betting ticket) corresponding to the bet of the user U1 to the server 10.

Next, the betting accepting unit 11c of the server 10 receives the betting request information transmitted from the user terminal 20c, and accepts the bet of the user U3 for the second betting ticket with the same content as the betting ticket (including the first betting ticket) corresponding to the bet of the user U1 (step S200).

Next, the setting unit 11e sets the dividend ratio (14.2 times) of the second betting ticket by adding the first additional dividend ratio (0.5 times) to the first basic dividend ratio (13.7 times) specified in the second betting ticket since the user U3 bet for a betting ticket with the same contents as the betting ticket corresponding to the bet of the user U1 (more specifically, the user U3 bet on the second betting ticket that specified the same betting contents as the first betting ticket (the trio where racehorses numbered 3, 5 and 7 are selected) specified by the user U1) (step S210).

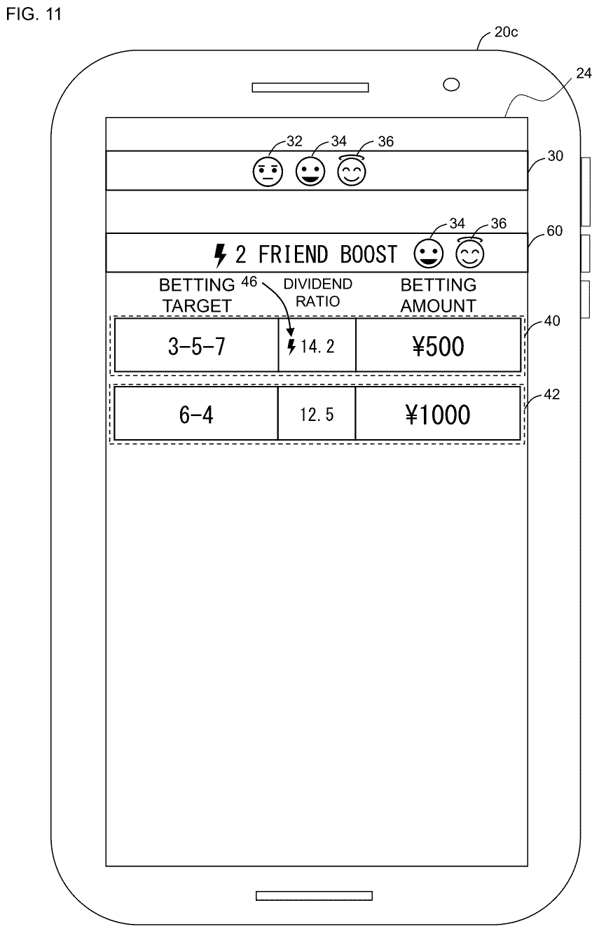

FIG. 11 is an example of a shared screen displayed on the display unit 24 of the user terminal 20c after the dividend ratio of the second betting ticket is set in step S210. As shown in FIG. 11, specific information identifying a plurality of users (the user U1, the user U2, the user U3) belonging to the group G, betting ticket information indicating the contents of the betting ticket corresponding to the bet of user U3 accepted by the betting accepting unit 11c, betting history information indicating that the users U2, U3 bet for the second betting ticket specifying the same betting contents as the first betting ticket specified by the user U1 are displayed on the display unit 24 of the user terminal 20c.

Specifically, the display control unit 11f displays face icons 32, 34 and 36 that respectively specify the user U1, the user U2 and the user U3 belonging to the group G as the specific information in the display area 30 of the display unit 24. The display control unit 11f also displays betting ticket information (betting target, dividend ratio, betting amount) indicating the contents of the betting ticket corresponding to the bet of the user U3 in the display areas 40 and 42 of the display unit 24.

The betting ticket information displayed in the display area 40 indicates “the trio where racehorses numbered 3, 5 and 7 are selected” as the betting target, “14.2” as the dividend ratio, and “500 yen” as the betting amount. In addition, the betting ticket information displayed in the display area 42 indicates “the exacta where the first place is number 6 and the second place is number 4” as the betting target, “12.5” as the dividend ratio, and “1000 yen” as the betting amount. In the area of the dividend ratio in the display area 40, the icon 46 indicating that the dividend ratio was increased to 14.2 times by betting with the second betting ticket based on the first betting ticket specified by the user U1 is displayed.

The betting history information displayed in the display area 60 indicates that the users U2, U3 (two users) identified by the face icons 34 and 36, respectively, bet for the second betting ticket based on the first betting ticket specified by the user U1.

As described in detail above, in the first embodiment, the server 10 (information processing device) includes a processor (the control unit 11). The processor accepts bets using a betting ticket with betting contents specified based on an operation for specifying a competition for betting by the first user (the user U1) and an operation for specifying betting contents (betting type, betting target, predetermined value of betting amount, etc.) for betting in a specified competition. The processor accepts a specification of the first betting ticket from among at least one betting ticket bet by the first user. The processor accepts bets of the second betting ticket that specifies the same betting content as the first betting ticket by accepting an operation to specify the first betting ticket by the second user (the users U2 and U3). The processor sets a dividend ratio (14.2 times) of the second betting ticket by adding a first additional dividend ratio (0.5 times) to a first basic dividend ratio (13.7 times) defined in the second betting ticket when the second user bet on the second betting ticket.

According to the first embodiment configured in this way, with the aim of increasing the dividend ratio (also referred to as dividend ratio boost), it is possible to encourage the second user to bet (shared betting) for the second betting ticket specifying the same betting content as the first betting ticket specified from among the betting tickets bet by the first user. In addition, with the aim of increasing the dividend ratio, by encouraging the second user to bet for a betting ticket specifying the same betting content as the betting ticket specified from among the betting tickets bet by the first user, when the second user bets, the number of required input items, and thus the number of input operations, is reduced, thereby reducing the operation load and preventing the occurrence of erroneous operations. Furthermore, in shared betting, even if the deadline for accepting bets is near (in other words, if the second user input bets normally, the second user will not be able to bet in time), the second user can bet with fewer input operations, in other words, can bet by shortening the input operation time.

In addition, in the first embodiment, the betting ticket corresponding to the bet of the user U1 is shared with the users U2 and U3 belonging to the same group G, but is not shared with a user not belonging to the group G (for example, a user belonging to a group different from the group G). Therefore, compared to the case where the betting ticket corresponding to the bet of the user U1 is shared without restriction with users unrelated to the user U1, it is possible to prevent security and privacy problems from occurring.

Further, in the above embodiment, when the users U2 and U3 bet by themselves, betting information indicating betting contents (for example, betting type, betting target, predetermined value of betting amount, etc.) based on betting operations is transmitted from the user terminals 20 operated by users U2 and U3 to the server 10. On the other hand, when users U2 and U3 perform the shared betting on the first betting ticket, specific information (for example, betting ID) that uniquely identifies the first betting ticket is transmitted from the user terminals 20 to the server 10. Thereby, compared to the case where the users U2 and U3 bet by themselves, the amount of information communication from the user terminals 20 to the server 10 is reduced and the communication load can be reduced. Furthermore, even if the specific information transmitted from the user terminal 20 to the server 10 is viewed by a user not belonging to the group G (for example, a user belonging to a group different from the group G), the user cannot refer to the betting contents bet by users U2 and U3, it is possible to prevent security and privacy problems such as the betting contents being disclosed to users unrelated to the users U2 and U3 from occurring.

Furthermore, when the users U2 and U3 perform betting operations themselves, it is common for them to view and consider information about each betting target on the Web when considering betting contents. By using shared betting, it becomes possible to bet for the second betting ticket by riding on the first betting ticket that was already considered by other users (the user U1), the number of web page views by the users U2 and U3 reduces, and the processing load on the server 10 can be reduced. Furthermore, the power consumption of the user terminals 20b, 20c can be reduced by reducing the amount of time the users U2, U3 spend considering by using the user terminals 20b, 20c.

In addition, in the first embodiment, the setting unit 11e may set the dividend ratio of the first betting ticket by adding a second additional dividend ratio to the second basic dividend ratio defined for the first betting ticket when the second user (the users U2, U3) bets on the second betting ticket that specifies the same betting contents as the first betting ticket. Here, the second basic dividend ratio may be the dividend ratio defined for the first betting ticket (specifically, the betting target) at the time when the first betting ticket is bet, or may be the dividend ratio defined for the first betting ticket at a time (for example, at the deadline for accepting bets) after the first betting ticket was bet.

Further, in the first embodiment, the setting unit 11e may change the first additional dividend ratio of the second betting ticket depending on whether or not the betting history (for example, balance of past bets or number of bets) of the second user (for example, the users U2, U3) satisfies a predetermined condition. For example, the setting unit 11e may increase the first additional dividend ratio of the second betting ticket compared to the case where the second user's balance of past bets (betting history) is positive (the predetermined condition is not satisfied) when the second user's balance of past bets (betting history) is negative (the predetermined condition is satisfied). Furthermore, the setting unit 11e may increase the first additional dividend ratio of the second betting ticket compared to the case where the number of past bets (betting history) of the second user is 100 or more (the predetermined condition is not satisfied) when the number of past bets (betting history) of the second user is less than 100 (the predetermined condition is satisfied).

Further, in the first embodiment described above, the specification accepting unit 11d may be able to accept a specification from a third user (for example, a user not belonging to the group G) for the first betting ticket. In this case, the setting unit 11e sets the dividend ratio of the second betting ticket by adding the first additional dividend ratio and a third additional dividend ratio to the first basic dividend ratio defined for the second betting ticket when the first betting ticket is specified by the third user. Here, the third additional dividend ratio are set, for example, based on a specification of the third user. The third additional dividend ratio are added to the basic dividend ratio defined for the betting ticket bet by all users (specifically, the first user, the second user, and the third user) that specify the same first betting ticket, respectively, and the dividend ratio of the betting ticket is set. In other words, when the first betting ticket is specified by the third user, all users that specified the same first betting ticket can obtain the benefit of an dividend ratio boost (addition of the third additional dividend ratio) based on the specification. As in present modification, the dividend ratio of the second betting ticket may be increased depending on the number of users that specified the same first betting ticket, specifically as the number of users increases. In addition, the dividend ratio of the second betting ticket may be increased depending on the number of times specified as the same first betting ticket, specifically as the number of times specified increases.

Further, in the first embodiment, the display control unit 11f may display the amount of increase in the dividend ratio of the second betting ticket regarding the case where the users (the users U2, U3) where the betting ticket was shared from the first user (the user U1) specify the first betting ticket. For example, when the first additional dividend ratio of a user differs depending on the betting history (rank, level, balance of bet, etc.) of the user that shared a betting ticket, it is possible to easily understand as to which user among users that shared a betting ticket should specify the first betting ticket to receive the largest increase in the dividend ratio of the second betting ticket (in other words, most benefit).

Further, in the first embodiment, the setting unit 11e may increase the first additional dividend ratio compared to the case where a cumulative amount is less than a prescribed amount when the cumulative amount of betting tickets bet based on the first betting ticket by the users (the users U2, U3) where the betting ticket was shared from the first user (the user U1) is more than the predetermined amount. Furthermore, the display control unit 11f may display the amount of money required until the cumulative amount reaches the predetermined amount when the cumulative amount is less than the predetermined amount.

Furthermore, in the first embodiment described above, the specification accepting unit 11d may limit an acceptation of specification of the first betting ticket by a second group user belonging to the second group (a group different from the group G) when a specification of the first betting ticket by a first group users (the users U1, U2, U3) belonging to the first group (the group G) is accepted. For example, the specification accepting unit 11d accepts a specification of the first betting ticket by the second group user belonging to the second group, and further limits the increase in the dividend ratio of the second betting ticket where the second group user bet by specifying the same betting contents as the first betting ticket when the first group user leaves the first group and joins the second group and shared the first betting ticket in the second group after the first group user (the user U1) specified and shared the first betting ticket in the first group.

### Second Embodiment

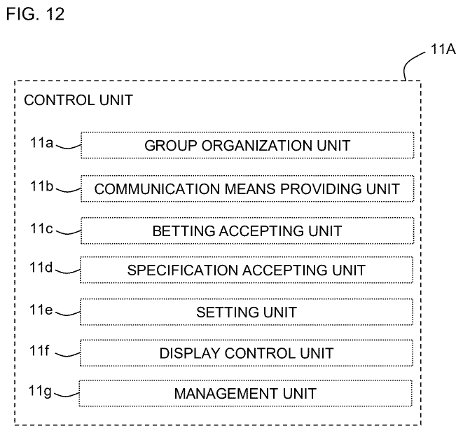

Next, a second embodiment, which is an example of present embodiment, will be described based on the drawings. FIG. 12 is a block diagram showing an example of the functional configuration of the server 10 (a control unit 11A) according to the second embodiment. In FIG. 12, components designated by the same reference numerals as those shown in FIG. 4 have the same functions, so a redundant explanation will be omitted here.

As shown in FIG. 12, the control unit 11A according to the second embodiment is configured to further include a management unit 11g as a functional configuration.

The management unit 11g manages a specifiable number of times associated with the first user (for example, the users U1, U2 and U3). Then, the specification accepting unit 11d controls so that the first user can specify the first betting ticket when the specifiable number of times satisfies a predetermined number of times (in other words, when the first user has the right to specify the betting ticket subject to increase the dividend ratio). On the other hand, the specification accepting unit 11d controls so that the first user can not specify the first betting ticket when the specifiable number of times does not satisfy the predetermined number of times (in other words, when the first user does not have the right to specify the betting ticket subject to increase the dividend ratio). For example, the management unit 11g manages to periodically increase the specifiable number of times associated with the first user.

According to the second embodiment configured in this way, it is possible to prevent the first user from specifying the first betting ticket indiscriminately because the first user cannot specify the first betting ticket when the specifiable number of times associated with the first user is less than the predetermined number of times.

It is noted that in the second embodiment, the management unit 11g may control the specifiable number of times based on the betting history of the first user (for example, the user U1). For example, the management unit 11g increases the specifiable number of times of the first user compared to the case where the first user's past betting frequency (betting history) is not high when if the first user's past betting frequency is high. Furthermore, the management unit 11g increases the specifiable number of times of the first user compared to the case where the first user's past betting amount (betting history) is not large when the first user's past betting amount is large. Furthermore, the management unit 11g increases the specifiable number of times of the first user compared to the case where the first user's past betting balance (betting history) is positive when the first user's past betting balance is negative. Furthermore, the management unit 11g increases the specifiable number of times of the first user compared to the case where the number of consecutive misses (betting history) is less than the predetermined number when the number of consecutive misses as the past betting results of the first user is more than a predetermined number of times.

In the second embodiment, the display control unit 11f also may displays a specifiable number of times of a user (for example, the user U2, the user U3) where a betting ticket information was shared from the first user (for example, the user U1) on a screen where the shared betting ticket can be checked (for example, a screen where a plurality of users that shared betting ticket information can view it and can have a conversation between the plurality of users).

Further, in the second embodiment, the management unit 11g may manage a specifiable number of times for each of the betting type (for example, win, show) of the first betting ticket. In this case, the specification accepting unit 11d controls so that the first betting ticket for a betting type where the specifiable number of times is less than a predetermined number of times cannot be specified.

### Third Embodiment

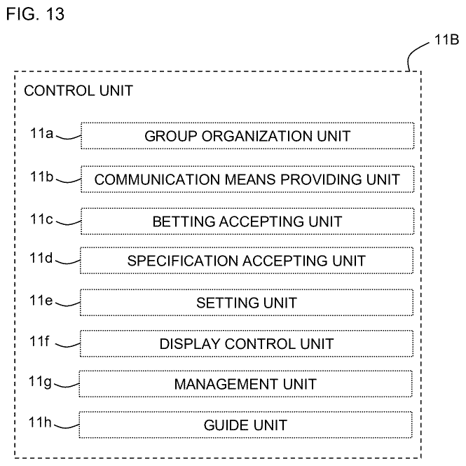

Next, a third embodiment, which is an example of present embodiment, will be described based on the drawings. FIG. 13 is a block diagram showing an example of the functional configuration of the server 10 (a control unit 11B) according to the third embodiment. In FIG. 13, the components designated by the same reference numerals as those shown in FIG. 12 have the same functions, so a redundant explanation will be omitted here.

As shown in FIG. 13, the control unit 11B according to the third embodiment is configured to further include a guide unit 11h as a functional configuration.

The guide unit 11h guides a betting based on the first betting ticket when a user (for example, the user U2, the user U3) where a betting ticket was shared from the first user (for example, the user U1) inputs the same betting content as the first betting ticket on an input screen (for example, betting screen) of a betting ticket.

According to the third embodiment configured in this way, it is possible, in order to increase a dividend ratio (a dividend ratio boost), to encourage a user to bet (shared betting) for a second betting ticket specifying the same betting contents as the first betting ticket when a user where a betting ticket was shared inputs the same betting content as a first betting ticket on an input screen of a betting ticket.

It is noted that the above embodiments are merely examples of implementation of the present embodiment, and the technical scope of the present embodiment should not be construed as limited by these embodiments. That is, present embodiment can be implemented in various forms without departing from its gist or main features.

### SUMMARY

### General Technical Problem

One object of present embodiment is to provide a good operating environment when a bettor bets.

### Technical Problem Corresponding to [Additional Note 1]

One object of present embodiment is to reduce an operational load and prevent an occurrence of erroneous operation when a bettor bets.

### Additional Note 1

The information processing device according to an example of present embodiment is an information processing device comprising a processor, wherein the processor accepts a bet of a betting ticket specifying a betting content based on an operation to specify a competition for betting by a first user and an operation to specify a betting content for betting for the specified competition, the processor accepts a specification of a first betting ticket from at least one betting ticket bet by the first user, the processor accepts a bet of a second betting ticket that specifies the same betting content as the first betting ticket by accepting an operation to specify the first betting ticket by a second user, and the processor sets dividend ratio of the second betting ticket by adding a first additional dividend ratio to a first basic dividend ratio defined in the second betting ticket when the second user bets on the second betting ticket.

According to the above information processing device, it is possible to reduce an operational load and prevent an occurrence of erroneous operation when a bettor bets.

### Technical Problem Corresponding to [Additional Note 2]

One object of present embodiment is to specify a first betting ticket from betting tickets shared with other users by a first user.

### Additional Note 2

The information processing device of additional note 1, wherein
the processor controls so that the first betting ticket can be specified from betting tickets shared with other users by the first user.

Thereby, it is possible to specify a first betting ticket from betting tickets shared with other users by a first user.

### Technical Problem Corresponding to [Additional Note 3]

One object of present embodiment is to also increase a dividend ratio of a first betting ticket when a second user bets on a second betting ticket that specifies the same betting object as a first betting ticket.

### Additional Note 3

The information processing device of additional note 1 or 2, wherein the processor sets a dividend ratio of the first betting ticket by adding a second additional dividend ratio to a second basic dividend ratio defined in the first betting ticket when the second user bets on the second betting ticket.

Thereby, it is possible to also increase a dividend ratio of a first betting ticket when a second user bets on a second betting ticket that specifies the same betting object as a first betting ticket.

### Technical Problem Corresponding to [Additional Note 4]

One object of present embodiment is for other users where a betting ticket was shared from a first user to easily understand whether or not the betting ticket is specified as a first betting ticket.

### Additional Note 4

The information processing device of any one of additional notes 1 to 3, wherein the processor displays betting tickets shared with other users by the first user so that the first betting ticket and a betting ticket not specified as the first betting ticket can be distinguished.

Thereby, it is possible for other users where a betting ticket was shared from a first user to easily understand whether or not the betting ticket is specified as a first betting ticket.

### Technical Problem Corresponding to [Additional Note 5]

One object of present embodiment is to suitably change a first additional dividend ratio of a second betting ticket according to a betting history of a second user.

### Additional Note 5

The information processing device of any one of additional notes 1 to 4, wherein the processor changes the first additional dividend ratio of the second betting ticket depending on whether or not a betting history of the second user satisfies a predetermined condition.

Thereby, it is possible to suitably change a first additional dividend ratio of a second betting ticket according to a betting history of a second user.

### Technical Problem Corresponding to [Additional Note 6]

One object of present embodiment is to prevent a first user from specifying a first betting ticket indiscriminately.

### Additional Note 6

The information processing device of additional note 5, wherein the processor manages a specifiable number of times associated with the first user, and the processor controls to prevent the first user from specifying the first betting ticket when the specifiable number of times is less than a predetermined number of times.

Thereby, it is possible to prevent a first user from specifying a first betting ticket indiscriminately because a first user cannot specify a first betting ticket when a specifiable number of times associated with a first user is less than a predetermined number of times.

### Technical Problem Corresponding to [Additional Note 7]

One object of present embodiment is to suitably control a specifiable number of times of a first user based on a betting history of a first user.

### Additional Note 7

The information processing device of additional note 6, wherein
the processor controls the specifiable number of times of the first user based on a betting history of the first user.

Thereby, it is possible to suitably control a specifiable number of times of a first user based on a betting history of a first user.

### Technical Problem Corresponding to [Additional Note 8]

One object of present embodiment is to encourage user where a specifiable number of times is large among other users where betting ticket information was shared from a first user to specify a first betting ticket.

### Additional Note 8

The information processing device of additional note 6, wherein
the processor displays a specifiable number of times of a user where a betting ticket information was shared from the first user on a screen where the shared betting ticket can be checked.

Thereby, it is possible to encourage user where a specifiable number of times is large among other users where betting ticket information was shared from a first user to specify a first betting ticket.

### Technical Problem Corresponding to [Additional Note 9]

One object of present embodiment is to limit a specification of a first betting ticket for betting type where a specifiable number of times is less than a predetermined number of times.

### Additional Note 9

The information processing device of additional note 6, wherein
the processor manages a specifiable number of times for each betting type of the first betting ticket, and the processor controls so that the first betting ticket cannot be specified for a betting type where a specifiable number of times is less than a predetermined number of times.

Thereby, it is possible to limit a specification of a first betting ticket for betting type where a specifiable number of times is less than a predetermined number of times.

### Technical Problem Corresponding to [Additional Note 10]

One object of present embodiment is to increase a dividend ratio of a second betting ticket by further adding a third additional dividend ratio to a first basic dividend ratio when a first betting ticket is specified by a third user.

### Additional Note 10

The information processing device of any one of additional notes 1 to 9, wherein the processor accepts a specification of the first betting ticket from a third user, and the processor sets a dividend ratio of the second betting ticket by adding the first additional dividend ratio and a third additional dividend ratio to the first basic dividend ratio when a specification of the first betting ticket from the third user was accepted.

Thereby, it is possible to increase a dividend ratio of a second betting ticket by further adding a third additional dividend ratio to a first basic dividend ratio when a first betting ticket is specified by a third user.

### Technical Problem Corresponding to [Additional Note 11]

One object of present embodiment is to easily understand an amount of increase in a dividend ratio of a second betting ticket when in the case a user where a betting ticket was shared specifies a first betting ticket.

### Additional Note 11

The information processing device of any one of additional notes 1 to 10, wherein the processor displays an amount of increase in a dividend ratio of the second betting ticket in the case a user where a betting ticket was shared from the first user specifies the first betting ticket.

Thereby, it is possible to easily understand an amount of increase in a dividend ratio of a second betting ticket when in the case a user where a betting ticket was shared specifies a first betting ticket.

### Technical Problem Corresponding to [Additional Note 12]

One object of present embodiment is, in order to further increase a dividend ratio (a dividend ratio boost), to encourage a user to bet for a betting ticket based on a first betting ticket (shared betting) so that a cumulative amount of betting tickets bet by a user where a betting ticket was shared is a predetermined amount.

### Additional Note 12

The information processing device of any one of additional notes 1 to 11, wherein the processor increases the first additional dividend ratio compared to the case where a cumulative amount is less than a predetermined amount when the cumulative amount of betting tickets bet by specifying the same betting content as the first betting ticket by a user where a betting ticket was shared from the first user is more than the predetermined amount.

Thereby, it is possible, in order to further increase a dividend ratio (a dividend ratio boost), to encourage a user to bet for a betting ticket based on a first betting ticket (shared betting) so that a cumulative amount of betting tickets bet by a user where a betting ticket was shared is a predetermined amount.

### Technical Problem Corresponding to [Additional Note 13]

One object of present embodiment is for a user where a betting ticket was shared to easily understand a standard (necessary amount of money) for a cumulative amount to reach a predetermined amount.

### Additional Note 13

The information processing device of additional note 12, wherein the processor displays an amount required until the cumulative amount reaches the predetermined amount when the cumulative amount is less than the predetermined amount.

Thereby, it is possible for a user where a betting ticket was shared to easily understand a standard (necessary amount of money) for a cumulative amount to reach a predetermined amount.

### Technical Problem Corresponding to [Additional Note 14]

One object of present embodiment is, in order to increase a dividend ratio (a dividend ratio boost), to encourage a user to bet for a second betting ticket based on a first betting ticket (shared betting) when a user where a betting ticket was shared inputs the same betting content as a first betting ticket on an input screen of a betting ticket.

### Additional Note 14

The information processing device of additional note 13, wherein the processor guides a betting based on the first betting ticket when a user where a betting ticket was shared from the first user inputs the same betting content as the first betting ticket on an input screen of a betting ticket.

Thereby, it is possible, in order to increase a dividend ratio (a dividend ratio boost), to encourage a user to bet for a second betting ticket based on a first betting ticket (shared betting) when a user where a betting ticket was shared inputs the same betting content as a first betting ticket on an input screen of a betting ticket.

### Technical Problem Corresponding to [Additional Note 15]

One object of present embodiment is to reduce an operational load and prevent an occurrence of erroneous operation when a bettor bets.

### Additional Note 15

The information processing method according to an example of present embodiment is an information processing method, wherein a processor accepts a bet of a betting ticket specifying a betting content based on an operation to specify a competition for betting by a first user and an operation to specify a betting content for betting for the specified competition, a processor accepts a specification of a first betting ticket from at least one betting ticket bet by the first user, a processor accepts a bet of a second betting ticket that specifies the same betting content as the first betting ticket by accepting an operation to specify the first betting ticket by a second user, and a processor sets a dividend ratio of the second betting ticket by adding a first additional dividend ratio to a first basic dividend ratio defined in the second betting ticket when the second user bets on the second betting ticket.

According to the above information processing method, it is possible to reduce an operational load and prevent an occurrence of erroneous operation when a bettor bets.

### Technical Problem Corresponding to [Additional Note 16]

One object of present embodiment is to reduce an operational load and prevent an occurrence of erroneous operation when a bettor bets.

### Additional Note 16

The information processing program according to an example of present embodiment is an information processing program for causing a processor to execute: a process that accepts a bet of a betting ticket specifying a betting content based on an operation to specify a competition for betting by a first user and an operation to specify a betting content for betting for the specified competition, a process that accepts a specification of a first betting ticket from at least one betting ticket bet by the first user, a process that accepts a bet of a second betting ticket that specifies the same betting content as the first betting ticket by accepting an operation to specify the first betting ticket by a second user, and a process that sets a dividend ratio of the second betting ticket by adding a first additional dividend ratio to a first basic dividend ratio defined in the second betting ticket when the second user bets on the second betting ticket.

According to the above information processing program, it is possible to reduce an operational load and prevent an occurrence of erroneous operation when a bettor bets.

### REFERENCE SIGNS LIST

1: betting system, 10: server, 11, 11A, 11B: control unit, 11a: group organization unit, 11b: communication means providing unit, 11c: betting accepting unit, 11d: specification accepting unit, 11e: setting unit, 11f: display control unit, 11g: management unit, 11h: guide unit, 12: storage unit, 13: communication unit, 14: operation input unit, 15: monitor, 16: system bus, 20, 20a, 20b, 20c: user terminal, 21: control unit, 22: storage unit, 23: communication unit, 24: display unit, 25: speaker, 26: microphone, 27: camera, 28: operation button, 29: system bus, 32, 34, 36: face icon, 40, 42, 60: display area, 45, 46: icon, 50, 52, 54: button, U, U1, U2, U3: user

1. An information processing device comprising a processor, wherein
the processor accepts a bet of a betting ticket specifying a betting content based on an operation to specify a competition for betting by a first user and an operation to specify the betting content for betting for the specified competition,
the processor accepts a specification of a first betting ticket from at least one betting ticket bet by the first user,
the processor accepts a bet of a second betting ticket that specifies the same betting content as the first betting ticket by accepting an operation to specify the first betting ticket by a second user, and
the processor sets a dividend ratio of the second betting ticket by adding a first additional dividend ratio to a first basic dividend ratio defined in the second betting ticket when the second user bets on the second betting ticket.

2. The information processing device of claim 1, wherein
the processor controls so that the first betting ticket can be specified from betting tickets shared with other users by the first user.

3. The information processing device of claim 1, wherein
the processor sets a dividend ratio of the first betting ticket by adding a second additional dividend ratio to a second basic dividend ratio defined in the first betting ticket when the second user bets on the second betting ticket.

4. The information processing device of claim 1, wherein
the processor displays betting tickets shared with other users by the first user so that the first betting ticket and a betting ticket not specified as the first betting ticket can be distinguished.

5. The information processing device of claim 1, wherein
the processor changes the first additional dividend ratio of the second betting ticket depending on whether a betting history of the second user satisfies a predetermined condition or not.

6. The information processing device of claim 1, wherein
the processor manages a specifiable number of times associated with the first user, and
the processor controls to prevent the first user from specifying the first betting ticket when the specifiable number of times is less than a predetermined number of times.

7. The information processing device of claim 6, wherein
the processor controls the specifiable number of times of the first user based on a betting history of the first user.

8. The information processing device of claim 6, wherein
the processor displays a specifiable number of times of a user where a betting ticket information was shared from the first user on a screen where the shared betting ticket can be checked.

9. The information processing device of claim 6, wherein
the processor manages a specifiable number of times for each betting type of the first betting ticket, and
the processor controls so that the first betting ticket cannot be specified for a betting type where a specifiable number of times is less than a predetermined number of times.

10. The information processing device of claim 1, wherein
the processor accepts a specification of the first betting ticket from a third user, and
the processor sets a dividend ratio of the second betting ticket by adding the first additional dividend ratio and a third additional dividend ratio to the first basic dividend ratio when a specification of the first betting ticket from the third user was accepted.

11. The information processing device of claim 1, wherein
the processor displays an amount of increase in a dividend ratio of the second betting ticket in a case a user where a betting ticket was shared from the first user specifies the first betting ticket.

12. The information processing device of claim 1, wherein
the processor increases the first additional dividend ratio compared to a case where a cumulative amount is less than a predetermined amount when the cumulative amount of betting tickets bet by specifying the same betting content as the first betting ticket by a user where a betting ticket was shared from the first user is more than the predetermined amount.

13. The information processing device of claim 12, wherein
the processor displays an amount required until the cumulative amount reaches the predetermined amount when the cumulative amount is less than the predetermined amount.

14. The information processing device of claim 1, wherein
the processor guides a betting based on the first betting ticket when a user where a betting ticket was shared from the first user inputs the same betting content as the first betting ticket on an input screen of a betting ticket.

15. An information processing method, wherein
a processor accepts a bet of a betting ticket specifying a betting content based on an operation to specify a competition for betting by a first user and an operation to specify a betting content for betting for the specified competition,
a processor accepts a specification of a first betting ticket from at least one betting ticket bet by the first user,
a processor accepts a bet of a second betting ticket that specifies the same betting content as the first betting ticket by accepting an operation to specify the first betting ticket by a second user, and
a processor sets a dividend ratio of the second betting ticket by adding a first additional dividend ratio to a first basic dividend ratio defined in the second betting ticket when the second user bets on the second betting ticket.

16. A non-transitory computer readable medium that stores an information processing program for causing a processor to execute:
a process that accepts a bet of a betting ticket specifying a betting content based on an operation to specify a competition for betting by a first user and an operation to specify a betting content for betting for the specified competition,
a process that accepts a specification of a first betting ticket from at least one betting ticket bet by the first user,
a process that accepts a bet of a second betting ticket that specifies the same betting content as the first betting ticket by accepting an operation to specify the first betting ticket by a second user, and
a process that sets a dividend ratio of the second betting ticket by adding a first additional dividend ratio to a first basic dividend ratio defined in the second betting ticket when the second user bets on the second betting ticket.
